(19) United States
(12) Patent Application Publication
(10) Pub. No.: US 2009/0055636 A1
(43) Pub. Date: Feb. 26, 2009

(54) METHOD FOR GENERATING AND APPLYING A MODEL TO PREDICT HARDWARE PERFORMANCE HAZARDS IN A MACHINE INSTRUCTION SEQUENCE

(76) Inventors: Stephen J. Heisig, Tarrytown, NY (US); Joshua W. Knight, Mohegan Lake, NY (US); Rui Zhang, Oxford (GB)

Correspondence Address: DUKE W. YEE, YEE & ASSOCIATES, P.C., P.O. BOX 802333, DALLAS, TX, 75380, US

(21) Appl. No.: 11/843,386

(22) Filed: Aug. 22, 2007

(51) Int. Cl. G06F 9/30

(52) U.S. Cl. 712/244; 712/E09.032

(57) ABSTRACT

A computer implemented method, data processing system, and computer program product for generating and applying a model to predict hardware performance hazards in a machine instruction sequence. The illustrative embodiments generate rules which specify relationships between a first instruction code sequence and hardware performance hazards. This rule generation is performed as a machine task rather than a human task (e.g., traditional hand coding tools). When a second instruction code sequence is received, the rules are applied to the second instruction code sequence. Responsive to a prediction that execution of the second instruction code sequence will cause the hardware performance hazards, instructions in the second instruction code sequence that cause the hardware performance hazards are identified.

### BACKGROUND OF THE INVENTION

1. Field of the Invention

The present invention relates generally to an improved data processing system, and in particular to a computer implemented method, data processing system, and computer program product for generating and applying a model to predict hardware performance hazards in a machine instruction sequence.

2. Description of the Related Art

Software developers are typically unaware of certain interactions between the software they write and the hardware implementation on which the code will ultimately run. There are hardware behaviors that can be triggered by code sequences that are invisible to developers but may have a significant impact on the performance of the code. If developers are aware of the effect these hazards will have on the performance of their code, the developers could take action to reduce or avoid triggering the hazards. By avoiding hardware performance hazards, the resulting code will run faster and more efficiently. Some examples of the types of hazards include Address Generated Interlock (AGI), Operand Store Compare (OSC), Store Queue Full, Instruction Queue Empty, Non-Overlappable Fetches, and almost any other cause of pipeline bubbles that can be inferred from the structure of the code. However, a problem with existing software development processes is that software developers are currently unable to optimize their code for hardware implementations without having to run the code on the actual hardware and use specialized tools that require expert performance knowledge, thereby resulting in slower, less efficient code being generated.

There are currently several ways in which attempts may be made to minimize the number and severity of hardware performance hazards. Traditionally, software code is written by a developer based on functional requirements. Little thought is given to the code's behavior on actual hardware. The code is then evaluated by function testers and system testers. A team of performance experts may later evaluate the performance of this code when aggregated into a product on real hardware; however, this evaluation may take place months after the code was written. If there are large problems in specific places in the code, the performance experts may require that the developer make changes to the code. However, this process is a very large institutional loop. In addition, the team of performance experts uses benchmark workloads and specialized hardware instrumentation reduction tooling to analyze their results. Typically, only a small number of experts are used to evaluate a large amount of code.

Another method for minimizing the number and severity of hardware performance hazards is through the use of hand coded tools. While hand coded tools scan code to determine whether hazards exist, use of these tools is not widespread. Generating such tools is very expensive, requiring a large amount of domain knowledge, and the tool is brittle in the sense that a change to the hardware implementation may or may not require changes to the tool. Compilers generate machine code from high level languages and are aware of some hardware performance hazards. While these compilers try to minimize hazards, they are restricted by what the programmer codes, so the compilers still may cause bad performance behaviors even though the compilers contain hand coded knowledge about how code sequences behave. System data structures may force compilers into “pointer chasing” or other bad behaviors, leaving the compilers no chance of avoiding hazards. Compilers are also very general in the sense that the compilers try to optimize behavior over a number of implementations of an architecture and tend to evolve slowly. If a developer wants to know how a particular piece of code will perform on a specific machine (a machine which may not even be in existence yet), the existing art currently provides no practical way to determine this performance. Some performance sensitive parts of operating systems are coded in assembler language which is not compiled so compilers do not get any chance to optimize this code.

Cycle accurate hardware simulators are very large, very complex, and very proprietary tools that hardware designers use to simulate every aspect of a hardware implementation. These qualities prevent the cycle accurate hardware simulators from being distributed to software developers to use to check their code. Cycle accurate hardware simulators typically require the collection of special traces that are expensive and onerous to gather, so running a simulator against a new instruction sequence would increase the development cycle time even if the objections over releasing such a sensitive piece of code could be overcome. Another drawback of cycle accurate hardware simulators is that when cycle accurate hardware simulators identify that a particular instruction has suffered a stall, the cycle accurate hardware simulators typically do not reveal which instruction or sequence of instructions caused the stall. This is not very helpful to developers trying to overcome the hazard.

### SUMMARY OF THE INVENTION

The illustrative embodiments provide a computer implemented method, data processing system, and computer program product for generating and applying a model to predict hardware performance hazards in a machine instruction sequence. The illustrative embodiments comprise a tool that is given as input a human readable sequence of instructions (e.g. an assembly language listing or a trace (CP) output from a test run of a module) and indicates which instructions or combinations of instructions will cause pipeline/performance problems on a particular implementation of a given Instruction Set Architecture (ISA). With the illustrative embodiments, a developer of the software for which the instructions were generated (by an assembler or compiler) will be able to easily understand the performance implications of their code before the code is integrated and tested and then measured for performance on the machine in question.

The illustrative embodiments generate rules which specify relationships between a set of training instruction code sequences and hardware performance hazards. This rule generation is performed as a machine task rather than a human task (e.g., traditional hand coded tools). When a second instruction code sequence is received, the rules are applied to the second instruction code sequence. Responsive to a prediction that execution of the second instruction code sequence will cause the hardware performance hazards, instructions in the second instruction code sequence that cause the hardware performance hazards are identified.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in which the illustrative embodiments may be implemented;

FIG. 2 is a block diagram illustrating a first phase of a process for educating the rules-based system in accordance with the illustrative embodiments;

FIG. 3 is a block diagram illustrating a second phase of a process for exploiting the rules-based system in accordance with the illustrative embodiments;

FIG. 4 illustrates an example of an isolated sequence of instructions in accordance with the illustrative embodiments;

FIG. 5 illustrates the sequence of instructions in FIG. 4 as transformed into a format readable by the ILP system in accordance with the illustrative embodiments; and

FIG. 6 illustrates a Prolog program comprising the ILP system output for the sequence of instructions in FIG. 5 in accordance with the illustrative embodiments.

### DETAILED DESCRIPTION OF THE PREFERRED EMBODIMENT

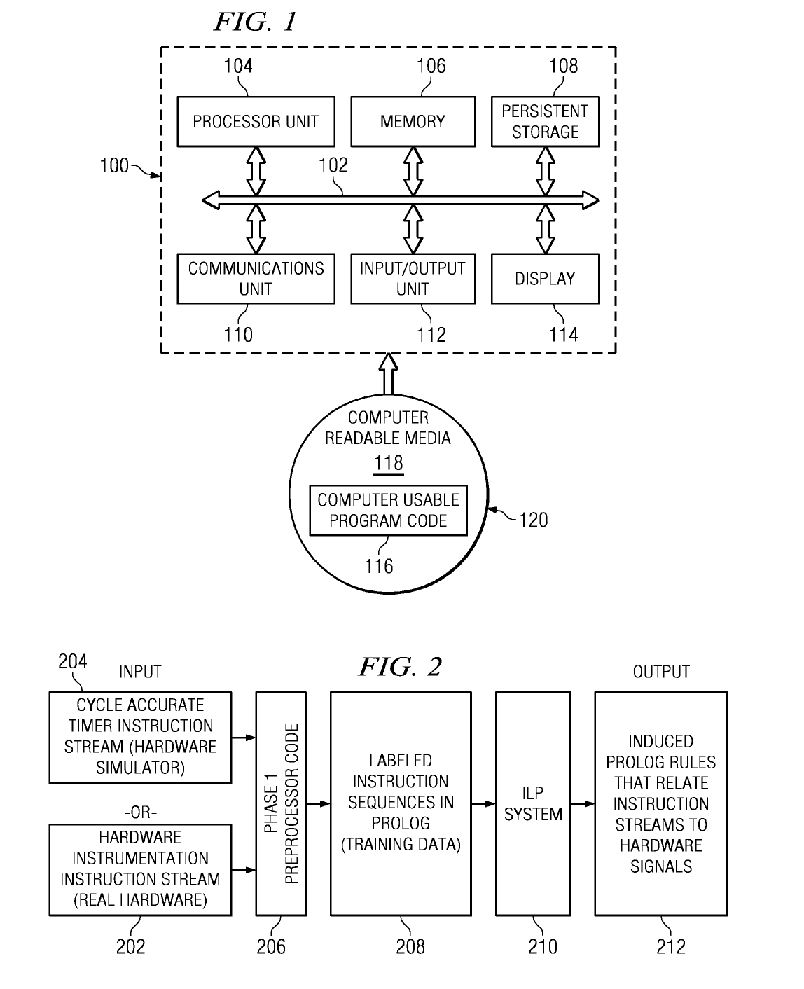

Turning now to FIG. 1, a diagram of a data processing system is depicted in accordance with an illustrative embodiment of the present invention. In this illustrative example, data processing system 100 includes communications fabric 102, which provides communications between processor unit 104, memory 106, persistent storage 108, communications unit 110, input/output (I/O) unit 112, and display 114.

Processor unit 104 serves to execute instructions for software that may be loaded into memory 106. Processor unit 104 may be a set of one or more processors or may be a multi-processor core, depending on the particular implementation. Further, processor unit 104 may be implemented using one or more heterogeneous processor systems in which a main processor is present with secondary processors on a single chip. As another illustrative example, processor unit 104 may be a symmetric multi-processor system containing multiple processors of the same type.

Memory 106, in these examples, may be, for example, a random access memory (RAM). Persistent storage 108 may take various forms depending on the particular implementation. For example, persistent storage 108 may contain one or more components or devices. For example, persistent storage 108 may be a hard drive, a flash memory, a rewritable optical disk, a rewritable magnetic tape, or some combination of the above. The media used by persistent storage 108 also may be removable. For example, a removable hard drive may be used for persistent storage 108.

Communications unit 110, in these examples, provides for communications with other data processing systems or devices. In these examples, communications unit 110 is a network interface card. Communications unit 110 may provide communications through the use of either or both physical and wireless communications links.

Input/output unit 112 allows for input and output of data with other devices that may be connected to data processing system 100. For example, input/output unit 112 may provide a connection for user input through a keyboard and mouse. Further, input/output unit 112 may send output to a printer. Display 114 provides a mechanism to display information to a user.

Instructions for the operating system and applications or programs are located on persistent storage 108. These instructions may be loaded into memory 106 for execution by processor unit 104. The processes of the different embodiments may be performed by processor unit 104 using computer implemented instructions, which may be located in a memory, such as memory 106. These instructions are referred to as computer usable program code or computer readable program code that may be read and executed by a processor in processor unit 104. The computer readable program code may be embodied on different physical or tangible computer readable media, such as memory 106 or persistent storage 108.

Computer usable program code 116 is located in a functional form on computer readable media 118 and may be loaded onto or transferred to data processing system 100. Computer usable program code 116 and computer readable media 118 form computer program product 120 in these examples. In one example, computer readable media 118 may be, for example, an optical or magnetic disc that is inserted or placed into a drive or other device that is part of persistent storage 108 for transfer onto a storage device, such as a hard drive that is part of persistent storage 108. Computer readable media 118 also may take the form of a persistent storage, such as a hard drive or a flash memory that is connected to data processing system 100.

Alternatively, computer usable program code 116 may be transferred to data processing system 100 from computer readable media 118 through a communications link to communications unit 110 and/or through a connection to input/output unit 112. The communications link and/or the connection may be physical or wireless in the illustrative examples. The computer readable media also may take the form of non-tangible media, such as communications links or wireless transmissions containing the computer readable program code.

The different components illustrated for data processing system 100 are not meant to provide architectural limitations to the manner in which different embodiments may be implemented. The different illustrative embodiments may be implemented in a data processing system including components in addition to or in place of those illustrated for data processing system 100. Other components shown in FIG. 1 can be varied from the illustrative examples shown.

For example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106 or a cache such as found in an interface and memory controller hub that may be present in communications fabric 102.

The illustrative embodiments provide a rule-based expert system that identifies machine code instruction sequences that will incur hardware performance hazards and may significantly impact system performance. The rules are induced from past examples of instruction sequences via a machine learning technique known as Inductive Logic Programming (ILP). The rules are then implemented in a rule-based model embodied as a logic program automatically generated from the instruction sequences examples.

The rule-based expert system in the illustrative embodiments provides a better way to reduce the incidence of hardware performance hazards by empowering individual developers to understand how their code will behave (since they are most familiar with the code's logic) and allow the developers to make changes immediately after the code is written, rather than waiting months (and avoid resending the code through function and system test if changes are made). Consequently, the maximum number of the most relevant experts (all the code developers) may be involved in avoiding hardware performance hazards while the code is being created, rather than waiting until the code has been through test and concentrating a small group of performance experts on the problems.

To make software developers conscious of hardware performance hazards and allow them to write faster and more efficient code, the expert system in the illustrative embodiments is a tool that is trained using cycle accurate simulator data or hardware instrumentation data and learns rules in the form of a Prolog program. Prolog, short for PROgramming in LOGic, is a logical and declarative programming language. The Prolog program in the illustrative embodiments characterizes the structure of code sequences that will invoke various hardware performance hazards. This program can then be run against code sequences a developer has just created to determine what kinds of hazards the code may provoke. These hazards may be displayed to the developer in a format easily understandable to the developer. The developer may then be able to reduce or eliminate these hazards by altering the code.

In contrast with existing methods for minimizing the number and severity of hardware performance hazards, the illustrative embodiments are purely based on software, thereby eliminating any requirement on running the code on actual hardware. Code may be optimized for a machine that does not yet exist, thus shortening the development cycle time. The expert system in the illustrative embodiments is compact and computationally efficient, such that the expert system can be run quickly by developers as part of their unit test. Since the expert system only learns the structure of instruction sequences that are liable to cause hazards, the expert system does not embody the entire architecture and so is less proprietary and sensitive than a cycle accurate hardware simulator.

The use of ILP to induce the rules from past examples of instruction sequences eliminates the laborious and error-prone process of manually analyzing hazards and hand encoding rules. Such automation makes it far less expensive to repeat the process for new machine implementations and new hazards. One important advantage of the expert system in the illustrative embodiments is that the expert system makes generating and regenerating the expert system rules a machine task rather than a human task. The encapsulation of the learned rules in a tool separates the rule generation phase from the use phase of the rules. This separation simplifies the expert system in that the expert system may contain several versions of rules depending on the specific version of the hardware to be used for analysis. In addition, the existence of human understandable rules provides insights into how the hardware is actually behaving (as opposed to how the designers thought it would behave).

The expert system in the illustrative embodiments provides several additional advantages. First, the expert system is small, computationally efficient, and does not contain an embodiment of the entire hardware architecture, making the system suitable for distribution to software developers. This efficiency allows developers to become involved in performance optimizing their code, rather than restricting this activity to a specialized performance team. Second, the input to the expert system is an instruction sequence similar to what is already captured by developers in function or system test. Thus, no additional workload is required of developers to generate data for the expert system. Third, the expert system may be run immediately after the code is executed the first time, allowing developers a chance to understand the implications of their code and to make changes quickly while still in development mode. The developers are able to iterate and optimize their code before the code goes through function test and system test. Fourth, the rules may be learned from hardware simulator output so that rules for implementations that do not currently have physical embodiments may be created. This process allows developers to optimize their code for the next generation of hardware. Fifth, the expert system is applied to machine code. Consequently, the expert system may be used to analyze code that was originally written in any high level language, including PLX, C, C++, Java, or Assembler, among others. Sixth, the expert system rules characterize the behavior of the hardware in a human understandable way (e.g., a Prolog program). This characterization may provide insights to hardware designers about how the hardware is actually behaving.

As with most machine learning applications, two phases are used in the expert system—education and exploitation. The first phase of education is required to process the training data and build the model. The second phase of exploitation applies the rules-based model to test data to generate predictions against the test data set. These predictions are then used by developers to optimize the performance of their code (by avoiding hazards).

FIG. 2 is a block diagram illustrating a first phase of a process for educating the expert system in accordance with the illustrative embodiments. In phase one, raw training data is used to educate the expert system. This raw training data may include input data comprising a set (e.g., hundreds) of instruction sequences. The input data may include hardware instrumentation data (hardware instrumentation instruction stream 202) from existing hardware that comprises signals for instructions that encounter performance hazards, or cycle accurate simulator data (cycle accurate timer instruction stream 204) that comprises signals for instructions that encounter performance hazards, or a combination of both. The input data is processed by preprocessor code 206, which transforms the input data to a code format (e.g., labeled instruction sequences in Prolog 208) recognizable by the ILP system. Each instruction sequence in the set of instruction sequences is ‘labeled’ to indicate whether or not the particular instruction sequence will incur a particular hazard. Preprocessor code 206 transformation process will identify both positive and negative sequences of instructions with respect to a certain signal. The labeled instruction sequences in Prolog 208 are then provided to ILP system 210 for processing. ILP system 210 comprises code which generates output 212 of data comprising rules that relate the structure of instruction streams to hardware signals. In other words, the ILP outputs rules which describe the structure of instruction sequences which can cause performance hazards.

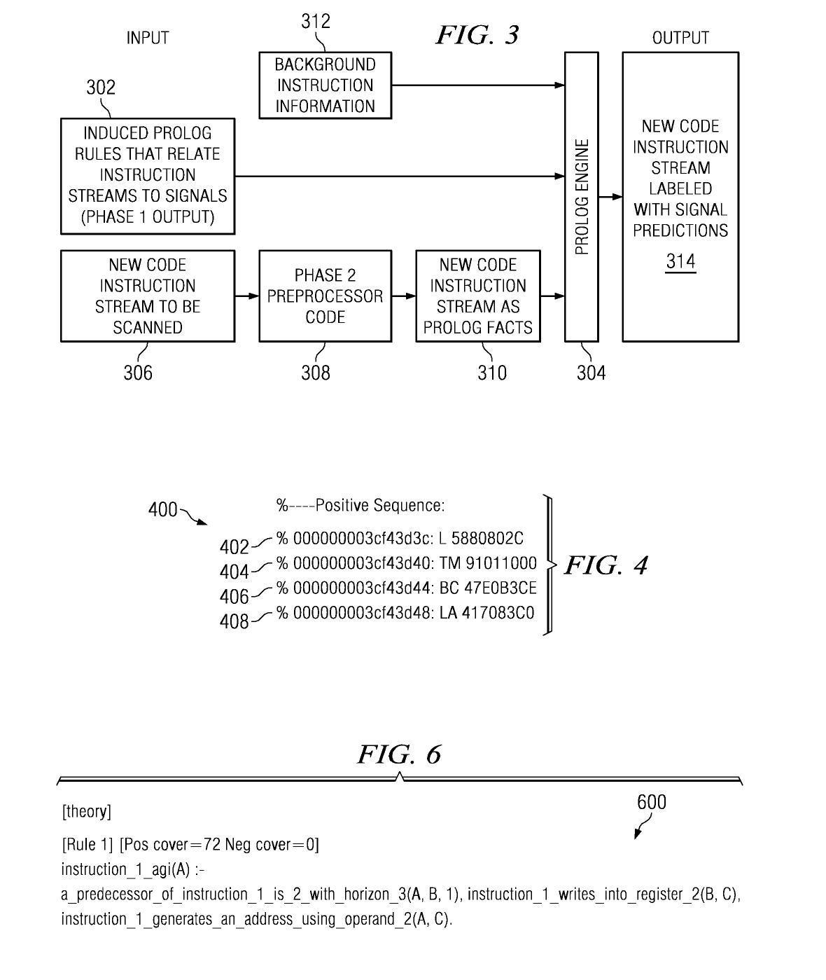

FIG. 3 is a block diagram illustrating a second phase of a process for exploiting the rules-based system in accordance with the illustrative embodiments. In phase two, induced Prolog rules that relate instruction streams to hardware signals 302 are provided as input data to Prolog engine 304 in the ILP system. Induced Prolog rules that relate instruction streams to hardware signals 302 comprise output 212 of phase one in FIG. 2.

Input data to Prolog engine 304 also comprises the new code instruction stream to be scanned 306. New code instruction stream 306 comprises the machine instruction sequences created by the developer and which the developer desires to analyze. Like the input data in FIG. 2, new code instruction stream 306 is first processed by preprocessor code 308, which transforms new code instruction stream 306 to a code format (e.g., new code instruction stream as Prolog facts 310) recognizable by Prolog engine 304. New code instruction stream as Prolog facts 310 is then provided to Prolog engine 304.

In addition to induced Prolog rules that relate instruction streams to hardware signals 302, some amount of background knowledge (also expressed in Prolog) is supplied as input to the ILP system. Background instruction information 312 is used to speed up the process in phase two by making explicit some facts that are commonly known but would require extra processing by the ILP system to learn. In general, this background information consists of architectural characteristics that are constant across implementations and publicly known. An example would be the fact that a “load” instruction writes to a register.

Prolog engine 304 then applies the Prolog rules 302 learned in phase one to the new Prolog facts 310 and background instruction information 312 and generates an output which predicts if any of the instruction sequences in the new Prolog facts 310 will see a certain hazard signal according to the rule for predicting that signal. Output 314 of Prolog engine 304 is the prediction based on the input Prolog rules. Output 314 is a prediction which comprises a new code instruction stream labeled with signal predictions. These predictions are used by the software developer to decide how to restructure the code to avoid the hazard. Additional Prolog code may be provided to identify all the variables in a rule for examples that indicate a signal will occur. Consequently, an instruction suffering an address generated interlock hazard will be displayed to a user as well as the instruction that caused the hazard.

FIG. 4 illustrates an example of an isolated sequence of instructions in accordance with the illustrative embodiments. This example comprises a sequence of instructions 400 that has been isolated from cycle accurate timer output as positive for the address generated interlock signal on the last instruction. In this example, ‘Positive Sequence’ is the ‘label’ for sequence of instructions 400 and indicates that sequence of instructions 400 will suffer an address generated interlock. Sequence of instructions 400 comprise machine instructions, such as hardware instrumentation instruction stream 202 or cycle accurate timer instruction stream 204 in FIG. 2, which comprise input data provided to the expert system in phase one.

Instruction 402 is a load (L) instruction which sets the address of the register (register 8) for the load instruction. Instruction 404 is a test under mask (TM) instruction, and instruction 406 is a branch on condition (BC) instruction. Instruction 408 is a load address (LA) instruction which uses register 8 to perform the load address operation. However, since the load address instruction 408 may start execution before the load instruction 402 has completed, an address generated interlock hazard may occur.

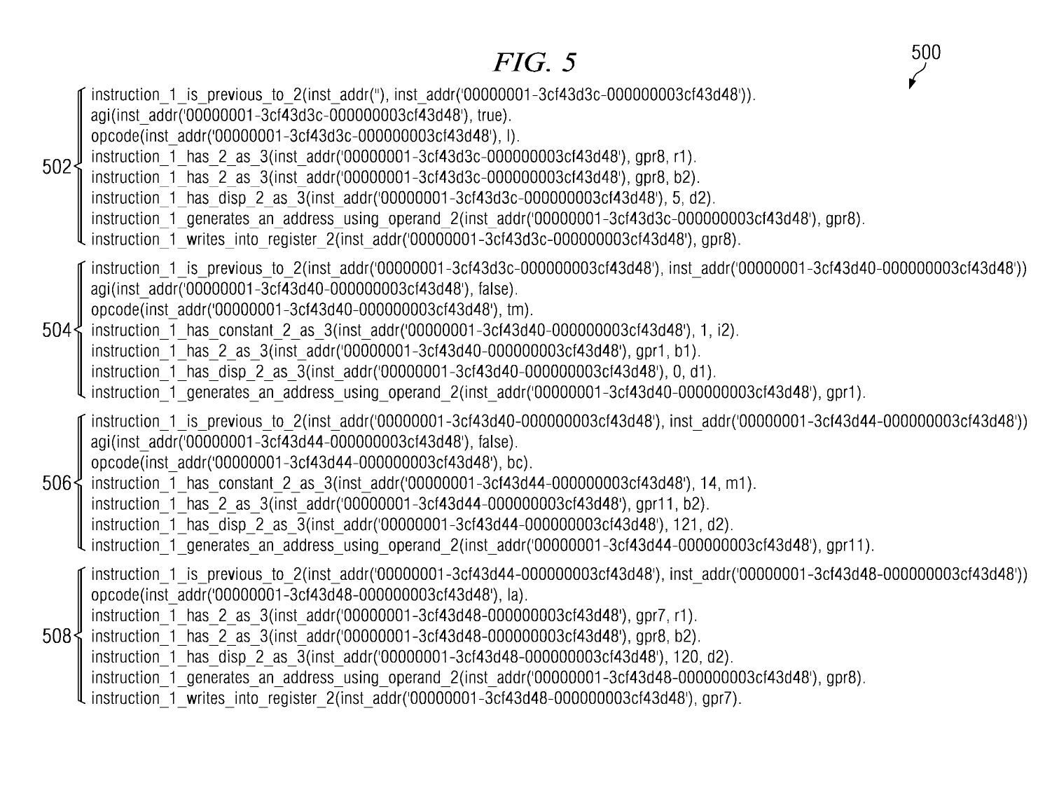

FIG. 5 illustrates the sequence of instructions in FIG. 4 as transformed into a format readable by the ILP system in accordance with the illustrative embodiments. The sequence of instructions in FIG. 4 comprises input data which is encoded into Prolog language by preprocessor code 206 in FIG. 2. This transformation process comprises labeling instruction sequences 500 in a format which the ILP system can use. In this example, labeled instruction 502 comprises the transformed instruction 402 in FIG. 4. Likewise, labeled instructions 504, 506, and 508 comprise the transformed instructions 404, 406, and 408, respectively, in FIG. 4. The labeled instructions 502-508 comprise a sample of (there may be hundreds of sequences required to learn the rule) the training data 208 which is provided to the ILP system 210 in FIG. 2.

FIG. 6 illustrates an example Prolog program comprising the ILP system output for the sequence of instructions in FIG. 5 in accordance with the illustrative embodiments. Output 600 of the ILP system is a Prolog program that represents a theory relating facts to the signal the ILP system was asked to predict. The theory in output 600 states a rule that an instruction A will suffer an address generated interlock if instruction A has a predecessor instruction B within one instruction of instruction A that writes into a register which instruction A uses to generate an address. An address generated interlock is one of the hardware performance hazards developers would like to avoid, so this very compact rule encapsulates the circumstances under which the hazard will occur.

While the illustrative embodiments are described specifically in terms of detecting performance hazards, it should be noted that the expert system may also be used to predict other code behaviors based on the structure of the code sequence. Some examples of other code behaviors include functional problems such as using a variable that has not been initialized, or security related problems such as copying data after switching to an authorized key. The illustrative embodiments may be useful in characterizing and detecting various kinds of code behaviors. The code may then be scanned to detect instances where theses kinds of behaviors might occur.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for predicting code behaviors in a sequence of computer instructions in a hardware implementation, the computer implemented method comprising:
generating rules specifying relationships between a first instruction code sequence and hardware performance hazards;
responsive to receiving a second instruction code sequence, applying the rules to the second instruction code sequence; and
responsive to a prediction that execution of the second instruction code sequence will cause the hardware performance hazards, identifying instructions in the second instruction code sequence that cause the hardware performance hazards.

2. The computer implemented method of claim 1, further comprising:
restructuring the second instruction code sequence to prevent the hardware performance hazards.

3. The computer implemented method of claim 1, wherein generating rules specifying a relationship between a first instruction code sequence and hardware performance hazards further comprises:
obtaining data comprising one or more instruction code sequences;
using the data to train an inductive logic programming system to determine which instruction code sequences provoke hardware performance hazards; and
responsive to training the inductive logic programming system using the data, generating rules which describe a structure of the instruction code sequences that cause hardware performance hazards.

4. The computer implemented method of claim 3, wherein the data comprises one of hardware instrumentation data or cycle accurate hardware stimulator data.

5. The computer implemented method of claim 1, wherein generating rules specifying a relationship between a first instruction code sequence and hardware performance hazards further comprises:
building a model specifying the relationships between the first instruction code sequence and hardware performance hazards.

6. The computer implemented method of claim 5, wherein changes to an architecture of the hardware implementation is captured in a new model.

7. The computer implemented method of claim 1, wherein identifying instructions in the second instruction code sequence that cause the hardware performance hazards further comprises:
identifying relationships between the identified instructions and instructions suffering from the hardware performance hazards.

8. The computer implemented method of claim 1, wherein the identified instructions, instructions suffering from the hardware performance hazards, and the identified relationships are displayed to a user.

9. The computer implemented method of claim 1, wherein the rules are expressed in a logic programming language.

10. The computer implemented method of claim 1, wherein the rules are automatically generated using inductive logic programming.

11. The computer implemented method of claim 1, wherein the rules form a knowledge base specific to each hardware implementation of a data processing system.

12. The computer implemented method of claim 11, wherein multiple knowledge bases are used to predict code behaviors for the second instruction code sequence on each hardware implementation of the data processing system.

13. A data processing system for predicting code behaviors in a sequence of computer instructions in a hardware implementation, the data processing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to generate rules specifying relationships between a first instruction code sequence and hardware performance hazards; apply the rules to a second instruction code sequence in response to receiving the second instruction code sequence; and identify instructions in the second instruction code sequence that cause the hardware performance hazards in response to a prediction that execution of the second instruction code sequence will cause the hardware performance hazards.

14. A computer program product for predicting code behaviors in a sequence of computer instructions in a hardware implementation, the computer program product comprising:
a computer usable medium having computer usable program code tangibly embodied thereon, the computer usable program code comprising:
computer usable program code for generating rules specifying relationships between a first instruction code sequence and hardware performance hazards;
computer usable program code for applying the rules to a second instruction code sequence in response to receiving a second instruction code sequence; and
computer usable program code for identifying instructions in the second instruction code sequence that cause the hardware performance hazards in response to a prediction that execution of the second instruction code sequence will cause the hardware performance hazards.

15. The computer program product of claim 14, further comprising:
computer usable program code for restructuring the second instruction code sequence to prevent the hardware performance hazards.

16. The computer program product of claim 14, wherein the computer usable program code for generating rules specifying a relationship between a first instruction code sequence and hardware performance hazards further comprises:
computer usable program code for obtaining data comprising one or more instruction code sequences;
computer usable program code for using the data to train an inductive logic programming system to determine which instruction code sequences provoke hardware performance hazards; and
computer usable program code for generating rules which describe a structure of the instruction code sequences that cause hardware performance hazards in response to training the inductive logic programming system using the data.

17. The computer program product of claim 16, wherein the data comprises one of hardware instrumentation data or cycle accurate hardware simulator data.

18. The computer program product of claim 14, wherein the computer usable program code for identifying instructions in the second instruction code sequence that cause the hardware performance hazards further comprises:
computer usable program code for identifying relationships between the identified instructions and instructions suffering from the hardware performance hazards.

19. The computer program product of claim 14, wherein the rules are automatically generated using inductive logic programming.

20. The computer program product of claim 14, wherein the rules form a knowledge base specific to each hardware implementation of a data processing system, and wherein multiple knowledge bases are used to predict code behaviors for the second instruction code sequence on each hardware implementation of the data processing system.
